(19) United States
(12) Patent Application Publication
(10) Pub. No.: US 2025/0270811 A1
(43) Pub. Date: Aug. 28, 2025

(54) MODULE FOR A PLANT WALL

(71) Applicant: VERTIGE INTERNATIONAL, CENON (FR)

(72) Inventor: Didier DEMONCHY, CENON (FR)

(21) Appl. No.: 18/858,812

(22) PCT Filed: Apr. 24, 2023
(86) PCT No.: PCT/EP2023/060594

§ 371 Date: Dec. 18, 2024

(30) Foreign Application Priority Data
Apr. 27, 2022 (FR) FR2203942

(51) Int. Cl. E04C 1/39; E04C 1/41

(52) U.S. Cl. CPC E04C 1/395; E04C 1/41

(57) ABSTRACT

The invention relates to a module (1) for a plant wall comprising a prefabricated outer wall (10) prefabricated of reinforced concrete or prestressed concrete, the outer wall (10) comprising an attachment portion (101) and an accommodating portion (100) extending from a lower end (101b) of the attachment portion (101) in order to define a volume (102) in which a substrate (102.1) for growing plants is arranged, the wall (10, 11) comprising a tube (103) that opens into the volume, (102) on the one hand, and to the outside of the outer wall (10), on the other hand.

### TECHNICAL FIELD

The invention relates to the technical field of modules for plant walls and in particular to load-bearing wall modules.

### PRIOR ART

Today, urban areas are increasingly dense and faced with climate change; nature has become a priority. The fact of seeking to return nature to the heart of our cities has become an essential aspect in construction since plants produce our oxygen, remove pollution from our air, and make it possible to effectively combat the heat islands that are often encountered at the heart of the cities. The plants also make it possible to reduce atmospheric pollution by reducing the carbon dioxide contained in the air. The presence of plants also contributes to lowering the ambient temperature, by virtue of the phenomenon of evapotranspiration, that is to say of heat exchange between the water rejected by the plant and the air.

For many years, it has been known to make our cities greener by installing plants not only on rooftops but also on building facades. The use of planted facades is also widespread. In addition, the use of this type of restructured facade has an architectural impact since it is possible to create planted alignments making it possible to texture and personalize a building. It is in particular possible to create one or more planted lines surrounding or not surrounding the building, a vertical corridor providing a sense of verticality giving a feeling of height to the building, spot vegetation only on the balconies, or even an entirely planted wall. Beyond the aesthetic aspect, plants also make it possible to promote biodiversity, green infrastructure, and ecological connections.

Conventionally, these planted facades are parts attached to an existing load-bearing wall. However, the addition of siding to the existing wall necessarily requires a competent authority giving technical notice, to confirm that this siding has no impact on the structure of the wall. This constraint may be time-consuming, generating delays in the worksite and therefore in the delivery of the building. This constraint can also be financial as it can generate a cost overrun due to the involvement of the technical notice or in the modification of the siding following this notice.

In addition, existing solutions propose relatively small substrate volumes, thus limiting the size of the plants that it is possible to use. For reasons of weight supported by the structure, natural soils are excluded, since the local plants suitable for local soils are excluded. In order to replace natural soils, it is known to use technosols, namely soils dominated by their technical origin, with offer drainage and are lightweight, but as the available volume is restricted, the range of usable plants is limited.

The invention therefore takes place in this context and seeks to solve all of the aforementioned drawbacks. Thus, the invention seeks to propose a solution that makes it possible to plant a facade while allowing both a diversification of the plants installed on the facade but also to ensure that the structure does not undergo any modification to plant the vegetation therein, this solution could save time and money in the management of the structure.

### OVERVIEW OF THE INVENTION

The invention relates to a planted wall module, comprising an outer wall prefabricated from reinforced or prestressed concrete, the outer wall comprising an attachment portion and a receiving portion extending from a lower surface of the attachment portion to define a volume in which a plant growth medium is arranged, the wall comprising a duct opening into the volume on the one hand and outside the outer wall on the other hand.

The outer wall of the module can allow the plants to be received from the planted wall. The volume formed by the attachment portion and by the receiving portion can accommodate the growth medium without weight limitation and regardless of its density. The growth medium may, for example, be local soil extracted during earthworks. In one variant, the growth medium may be a commercially available medium. In one embodiment, the growth medium may comprise an upper layer of commercially available medium and a lower layer of local soil taken from earthworks or a single layer composed of a mixture of a commercially available medium and local soil taken from earthworks. Thus, the outer wall of the module can receive, for example, large herbaceous plants, grasses, small shrubs, or climbing, hanging, or creeping plants, or even a composition of a plurality of these plants.

The outer wall comprises a duct allowing the discharge of waste water resulting from the watering of the vegetation planted in the volume. Thus, the water does not stagnate in the volume or in the outer wall, thus avoiding moisture and the weakening of the module.

The planted wall module can make it possible to promote local, plant and/or animal biodiversity due to the diversity of plants that it can receive.

The wall module may be a wall portion, the inner wall of which can be made of reinforced concrete or prestressed concrete, that is to say that this wall may be load-bearing. The concrete may for example be a concrete of the cement and gravel type. The concrete can also be a wood concrete, in particular a mortar comprising water, crushed wood, and a mineral binder, or it may be water, wood chips and a mineral binder. Finally, the concrete may be a composite concrete. The fact that the module comprises a portion made of concrete allows it to be used as a load-bearing wall and therefore to directly be able to hide a facade as early as the construction phase while offering walls that insulate and seal the interior of the building constructed. In addition, the wall comprises a wastewater flow system that also allows rainwater running on the modules to pass through the volume and be discharged through the duct, thus avoiding the weakening of the wall.

Advantageously, the receiving portion forms an exterior surface of the module and the attachment portion forms an interior surface of the module.

The receiving portion can be adapted to receive the content of the volume, namely the medium and/or the local soil extracted during earth. The receiving portion can make it possible to retain the medium and the vegetation at the module.

The attachment portion can allow the volume comprising the medium and the vegetation to be attached to an inner wall. It is the attachment portion that can allow the volume to be integrated into the load-bearing wall.

The volume can be defined laterally by lateral portions of the outer wall, said lateral portions being able to be contiguous with the receiving and attachment portions. The volume can be open on the top.

Advantageously, the attachment portion and the receiving portion form a U-shaped profile.

In another embodiment, the attachment portion and the receiving portion form a V-shaped profile.

The attachment portion may be flat. The receiving portion can extend obliquely upward from the lower end of the attachment portion. The receiving portion may have an angle. The attachment portion and the receiving portion can form a volume whose upper end is open and whose lower end is closed by the junction of the two portions. The junction of the two portions may form a lower surface of the module.

The volume is defined in the U-shaped profile. This profile can make it possible to simplify manufacturing.

Advantageously, the exterior surface of the receiving portion comprises a plurality of niches.

The exterior surface of the receiving portion may have niches. The niches may in particular be substantially longitudinal grooves and can extend over the entire width of the receiving portion.

The niches can allow small wildlife, for example insects, to move and/or nest on the wall and thus promote biodiversity.

Advantageously, the duct extends from an upper surface of the outer wall to a lower surface of the outer wall, said duct comprises a bypass opening into the volume.

The duct may comprise a circular cross-section. The duct may advantageously comprise a diameter comprised between 15 mm and 35 mm, in particular between 20 mm and 30 mm. The duct may comprise an upper end and a lower end. The duct may pass through the outer wall from top to bottom. The duct may be a duct formed by molding in the attachment portion. In another embodiment, the duct can be a duct formed by a pipe mounted in the attachment portion.

The duct may comprise a connection part protruding from the lower surface of the module. The pipe may comprise an upper end comprising a flaring adapted to receive the connecting part of a duct protruding from an upper module.

The duct may comprise a bypass and comprises a first end that can be connected to the duct extending into the outer wall so that the duct and the bypass are substantially perpendicular to each other.

The bypass may comprise a second end that can be connected to the volume so that it opens into the medium. Advantageously, the bypass may open into a lower part of the volume and in particular into the draining layer.

In one embodiment, the module may comprise a second bypass whose first end is connected to the duct extending into the outer wall and the second end extends in a direction opposite the direction in which the receiving portion extends.

Advantageously, a draining layer is arranged in the volume, under the growth medium.

The draining layer may form a lower layer of the medium. The draining layer can make it possible to regulate soil moisture overflow and limit the establishment of a hydrostatic pressure within the volume of the module.

The draining layer may comprise granulates.

Advantageously, the module comprises an inner wall, separated from the outer wall by an insulating layer.

The insulator may comprise glass wool or mineral wool. Alternatively or additionally, the insulator may comprise wood chips or a material made from plant fibers. Alternatively or additionally, the insulator may comprise a polymer, in particular a high-density extruded polystyrene and/or a polyurethane foam.

Alternatively, the insulating layer between the inner wall and the outer wall can be replaced by an empty space.

In another embodiment, the outer wall can be alone without an inner wall or insulating layer.

The inner wall extends laterally over a length less than the outer wall, so that with respect to the outer wall, a lateral space is provided at each end of said inner wall.

In this embodiment, the empty space separating the inner wall and the outer wall is intended to be filled with concrete. Concrete can be poured into the empty space directly on the worksite.

Advantageously, the planted wall module comprises connecting bars adapted to fasten the outer wall and the inner wall to each other, said connecting bars passing through the insulating layer.

The connecting bars can allow the outer wall and the inner wall to be held together, as long as said walls are separated by an empty space, for example by being clamped.

The connecting bars can allow the outer wall and the inner wall to be held together so as to reinforce the module.

Advantageously, the outer wall and/or the inner wall comprises a connecting pin extending from a lower surface of this wall and a recess formed in this wall extending from an upper surface of this wall.

The connecting pin may project from the lower surface of the upper module. The connecting pin can be intended to be inserted into the recess of another module arranged under the module comprising said connecting pin.

The connecting pin can allow two modules to be easily assembled together to form a set of modules. The use of connecting pins makes it possible to assemble a plurality of vertically aligned modules together to mount a wall.

The connecting pin of the upper module is adapted to be inserted into the recess of the lower module arranged under the upper module.

The connecting pin can be sized as a function of the forces subjected to the modules between one another.

The recess adapted to receive the connecting pin can be filled with non-shrink mortar, that is to say of mortar allowing the sealing of the two superimposed modules.

The lower surface wherein the connecting pin is integrated and the upper surface wherein the recess extends are held against each other by mortar.

Advantageously, the module comprises a flap positioned on the upper surfaces of the inner and outer walls.

The flap may be a strip arranged to protect the module from water infiltrations. The same flap can cover the inner wall and the outer wall. The flap can act as the seal between two modules. The flap may be affixed by bonding.

The flap can be manufactured from an inert material and forming a sealed membrane, for example made of elastomer, in particular of EPDM (ethylene, propylene, diene monomer).

Advantageously, the upper surface of the inner wall is offset vertically from the upper surface of the outer wall.

The upper surface of the inner wall is higher than the upper surface of the outer wall. Under such circumstances, the flap may have a step shape.

The offsetting of the two upper surfaces can make it possible to improve the interlocking and the holding of two superimposed modules.

Advantageously, the lower surface of the inner wall is offset vertically from the lower surface of the outer wall.

The lower surface of the inner wall and the lower surface of the outer wall are offset in the same way as the upper surfaces.

The upper surface of the lower module is arranged to be complementary to the lower surface of the upper module.

Advantageously, the receiving portion comprises a bore formed under the volume.

In this embodiment, the drilling may be formed in the receiving portion, at the junction with the attachment portion.

In another embodiment, the bore may be non-existent in the receiving portion.

In the embodiment in which two modules can be mounted one on top of the other. The upper module can then comprise the drilling enabling the junction between the lower surface of the volume of the upper module and a portion of the upper surface of the volume of the lower module. The drilling may be filled with medium. The drilling may be longitudinal and open onto a lower surface and be aligned with the volume. Therefore, the drilling can make it possible to promote the biodiversity between different volumes of medium.

In one embodiment comprising a column of a plurality of modules, each of the modules, with the exception of the lower module of the column, may comprise the bore formed under the volume.

Advantageously, the module comprises an additional tube suitable for watering the medium.

The additional tube can be arranged at the surface of the volume, for example placed on the surface of the medium. The additional tube can be a sprinkler pipe comprising a plurality of holes or a plurality of nozzles to allow the flow of water into the medium.

The lateral walls of the volume may comprise an indentation adapted to support the additional tube.

The invention also relates to a planted wall comprising a plurality of modules.

The wall may be a load-bearing wall of a building. In another embodiment, the wall may be a retaining wall adapted to hold a backfill or an embankment.

The planted wall can also be called a biophilic wall, that is, one consisting of integrating nature into a built environment and of designing a place that can allow a modern building to be connected to the environment and to promote biodiversity.

In one embodiment, the wall may comprise a plurality of columns and/or a plurality of lines.

Advantageously, the modules of said plurality of modules are juxtaposed vertically and/or horizontally.

The planted wall may comprise a plurality of modules arranged one above the other to form a column. When two modules are juxtaposed vertically, the lower surface of a module adjoins the upper surface of another module.

The planted wall may comprise a plurality of modules arranged side by side one another to form a row. When two modules are juxtaposed horizontally, the lateral surface of an outer wall of a module adjoins the lateral surface of an outer wall of another adjacent module. The lateral walls of the outer wall can be arranged opposite each other to define a decompression groove in which a seal is provided.

Advantageously, the wall comprises a post and at least one of the modules of said plurality of modules is mechanically connected to the post.

The post can be a horizontal beam, that is to say a structural element arranged horizontally and can serve as a foundation or reinforcement.

In one embodiment, the horizontal beam may comprise a recess formed in an upper surface of said horizontal beam. The recess in the horizontal beam can allow the connecting pin to be housed protruding from the lower surface of the lower module of the wall. A seal may be arranged at the junction of the horizontal beam and the lower surface of the module. The seal may be a seal that blocks water and/or air. The seal can be adapted to be used as a facade joint.

The horizontal beam may comprise an insulating layer arranged to be positioned under the insulating layer of the module.

Advantageously, the wall comprises a slab extending perpendicularly to the modules and at least one of the modules of said plurality of modules is mechanically connected to the slab.

In one embodiment, at least one of the modules can be mounted directly on the slab. In another embodiment, at least one of the modules can be mounted on the slab by means of the horizontal beam.

In one embodiment, the slab can be cast under the surface of the soil, the horizontal beam passing through the surface of the soil so as to make the junction between said slab and said horizontal beam.

Advantageously, said module is connected to the slab by means of a holding bar supported by a post arranged in a space provided between the inner walls of said module and another module of said plurality of modules adjacent to said module.

The slab can come into line with the post, perpendicular to the plurality of modules. The holding bar may comprise a first arm engaged in the inner wall of said module and a second arm engaged in the slab, the arms being able to form an angle between them around the post. The holding bar may have an L-shaped profile.

In one variant, the holding bar can be perpendicular to the modules and engaged in the inner wall of said module carried by the slab and fit into one or more recesses of the slab.

The slab may comprise a recess in which the connecting pin of the upper module can be inserted.

Concrete can be poured into the space provided between two successive inner walls.

Advantageously, each module is attached to the slab with a pin of the outer wall of the module extending into a recess of the slab and/or a bar for holding the slab extending in a recess of the outer wall of the module; a guard rail may be mounted on the upper surface of the outer wall.

The guard rail may be made of steel or glass. The guard rail can be mounted on the upper surface of the module attachment portion.

The guard rail can be mounted on the module by sealing, in particular by mortar or by screwing.

Advantageously, at least two modules are juxtaposed horizontally so as to accommodate a post in the lateral spaces provided at the ends of the inner walls of these modules and facing each other, holding bars supported by the post being engaged in these inner walls.

The two horizontally juxtaposed modules are arranged in a straight line. In another embodiment, the two horizontally juxtaposed modules form an angle.

The inner wall comprises a lateral recess in which a reinforcement post can be installed. The pole may comprise connecting bars having a U-shape. The connecting bars can be arranged so that two ends of the U are in the direction of the inner wall. The ends of the connecting bar that can be sealed in said inner wall.

Each inner wall may comprise a rough strip at the junction with the post. The rough strip can allow better adhesion between the inner wall and the post and therefore better retention of two adjacent modules to one another.

When two modules are juxtaposed horizontally, their outer walls define between them a groove. The groove may in particular be a decompression groove. The groove may comprise a joint, in particular made of elastomer or neoprene, and a seal bottom that can be used to caulk said joint.

In the embodiment where two modules are juxtaposed vertically, that is superimposed so that the connecting pin of the upper module fits into the recess of the lower module.

In one embodiment, the wall comprises a cable, for example stainless steel, or a mesh, connecting two adjacent modules, in particular juxtaposed vertically or horizontally. This cable or this mesh allows a plant to grow from one module to the other.

The invention also relates to a balcony comprising a plurality of modules, the modules being juxtaposed horizontally.

In one embodiment, the module can form the wall of a balcony. Thus, in this embodiment, the attachment portion and the outer wall can be combined and the module can form a wall of the balcony. In this embodiment, the module can be mounted on a slab protruding from the facade and forming the surface of said balcony.

The module can be attached to said balcony by the connecting bar protruding from the lower surface of said module, said connecting bar being arranged to be inserted into said balcony.

The module may comprise a connecting bar comprising an L-shape and two ends. The connecting bar may be arranged so that one of the ends is fixed in said balcony and that the other of the ends is fixed in the attachment portion, at the connecting bar.

In this embodiment, a guard rail can be mounted on the upper surface of said module and in particular on the upper surface of said attachment portion.

In one embodiment of the balcony, the slab forming the surface of said balcony can be aligned with said modules so that said slab can separate two superimposed modules.

The invention also relates to a method for manufacturing a module according to the invention wherein the module is made by molding reinforced or prestressed concrete in a mold.

The niches can be made by printing during the molding of the outer wall. The niches can be produced by applying a silicone die mounted in the mold.

The invention also relates to a mold suitable for use in the method for manufacturing a module according to the invention.

### BRIEF DESCRIPTION OF THE FIGURES

Other advantages and features of the present invention are now described with the aid of an example that is purely illustrative and in no way limiting as to the scope of the invention, and based on the attached drawings, wherein the various figures represent:

FIG. 1 schematically represents a cross-sectional view along a transverse axis of a module according to one embodiment.

FIG. 2 schematically represents a cross-sectional view along a transverse axis of a wall portion comprising a plurality of modules according to one embodiment.

FIG. 3 schematically represents a cross-sectional view along a transverse axis of a wall portion comprising a plurality of modules according to a plurality of embodiments.

FIG. 4 schematically represents a cross-sectional view along a transverse axis of a wall portion comprising a plurality of modules according to one embodiment, said wall being depicted at the junction of two stories, in a non-seismic configuration.

FIG. 5 schematically represents a cross-sectional view along a transverse axis of a wall comprising a plurality of modules according to one embodiment, said wall being depicted at the junction of two stories, in a seismic configuration.

FIG. 6 schematically represents a cross-sectional view along a transverse axis of a protruding balcony comprising a module according to one embodiment.

FIG. 7 schematically represents a cross-sectional view along a transverse axis of a terrace aligned with a wall comprising a plurality of modules according to one embodiment.

FIG. 8 schematically represents a cross-sectional view along a transverse axis of a wall comprising a joinery section integrated into a plurality of modules according to one embodiment.

FIG. 9 schematically represents a cross-sectional view along a transverse axis of a retaining wall comprising a plurality of modules according to one embodiment.

FIG. 10 schematically represents a cross-sectional top view along a longitudinal axis of a joinery section integrated between two modules according to one embodiment.

FIG. 11 schematically shows a cross-sectional top view along a longitudinal axis of a wall comprising a plurality of modules juxtaposed horizontally in a row, according to one embodiment.

FIG. 12 schematically shows a cross-sectional top view along a longitudinal axis of a wall comprising a plurality of modules juxtaposed horizontally to form an exterior angle, according to one embodiment.

FIG. 13 schematically shows a cross-sectional top view along a longitudinal axis of a wall comprising a plurality of modules juxtaposed horizontally to form an interior angle, according to one embodiment.

FIG. 14 schematically shows a cross-sectional top view along a longitudinal axis of a wall comprising a plurality of modules juxtaposed horizontally to form an exterior angle greater than 90°, according to one embodiment.

In the following description, identical elements, by structure or function, appearing in different figures retain, unless otherwise specified, the same references.

### DESCRIPTION OF THE EMBODIMENTS

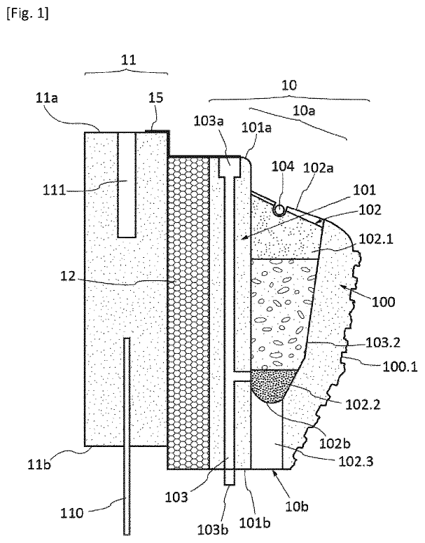

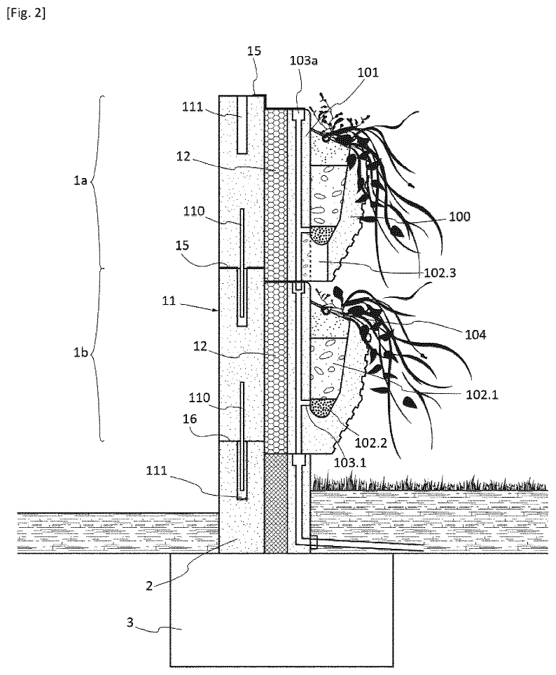

FIG. 1 shows a module 1 according to one embodiment of the invention. FIG. 2 to FIG. 14 describe a plurality of embodiments of walls and balconies comprising one or more modules 1 as described in FIG. 1.

The module described in FIG. 1 comprises an outer wall 10 and an inner wall 11. Each of the outer 10 and inner 11 walls comprises an upper surface 10a, 11a and a lower surface 10b, 11b. The outer wall 10 is prefabricated from reinforced concrete.

The outer wall 10 comprises an attachment portion 101 and a receiving portion 100. The attachment portion 101 and the receiving portion 100 each comprise an upper surface 101a, 100a and a lower surface 101b, 100b. The lower surface 100a of the receiving portion 100 is in continuity with the lower surface 101a of the attachment portion 101. The receiving portion 100 extends from the lower end 101b of the attachment portion 101. The receiving portion 100 comprises an angle. The receiving portion 100 can extend obliquely upward from the lower end 101a of the attachment portion 101. The receiving portion 100 comprises a plurality of niches extending longitudinally over the entire length of said receiving portion 100, said niches being made by the use of a die.

The attachment portion 101 and the receiving portion 100 form a U-shaped profile defining a volume 102. The volume 102 is defined laterally by lateral portions of the outer wall 10, said lateral portions being able to be contiguous with the receiving 100 and attachment 101 portions. In the volume 102 there is arranged a plant-growth medium 102a. In the embodiment described, the volume 102 comprises an upper layer of medium and a lower layer of local soil taken from earthworks. The volume 102 comprises an open upper end 102a. The upper end 102a comprises an additional tube 104 arranged at the surface of the volume 102, said additional tube 104 is a sprinkler pipe placed on the medium 102.1 to water it. The lateral walls of the volume 102 comprise an indentation adapted to support the additional tube 104. The volume 102 comprises a lower end 102b formed by the junction between the receiving portion 100 and the attachment portion 101. The lower end 102b of the volume 102 comprises a bore 102.3 formed in the receiving wall 100. When two modules 1 are superimposed, the bore 102.3 opens out firstly at the lower end 102b of the volume 102 and secondly at the medium 102.1 of the volume 102 of a lower adjacent module 1. The bore 102.3 is filled with medium 102.1. The medium 102.1 comes in particular from local soil extracted during earthworks. A draining layer 102.2 is arranged in the volume 102, under the growth medium 102.1. Thus, the draining layer 102.2 forms a lower layer of the medium 102.1. The outer wall 10 is adapted to receive the plants in the volume 102. The plants that the volume 102 may receive are, for example, large herbaceous plants, grasses, small shrubs, or climbing plants.

The outer wall 10 comprises a duct 103 extending from the upper surface 10 of the outer wall 10 to the lower surface 10b of the outer wall. The duct 103 has a circular cross-section. The duct 103 comprises an upper end 103a and a lower end 103b, the upper end 103a having a diameter greater than that of the rest of the duct and in particular greater than that of the lower end 103b. The lower end 103b of the duct 103 is a connection part that protrudes from the lower surface 10b of the outer wall 10.

The outer wall 10 comprises a bypass 103.1 adapted to evacuate the water contained in the medium 102.1. The bypass 103.1 comprises a first end connected to the duct 103 extending into the outer wall 10 so that the duct 103 and the bypass 103.1 are substantially perpendicular to each other. The bypass 103.1 comprises a second end which is connected to the volume 102 so as to open into the medium 102.1. The bypass 103.1 can open out at the lower end 102b of the volume 102 and in particular at the draining layer 102.2.

The inner wall 11 of the module 1 is a load-bearing wall. The inner wall 11 is prefabricated from reinforced concrete. The inner wall 11 comprises a connecting pin 110 extending from its lower surface 11b. The connecting pin 110 protrudes from the lower surface 11b. The inner wall 11 comprises a recess 111 extending from the upper surface 11a. The recess 111 is arranged to receive the connecting pin 110 from another module arranged on the module. Sealing mortar is inserted into the recess 111 during the insertion of the connecting pin 110.

The inner wall 11 is separated from the outer wall 10 by an insulating layer 12. The insulating layer 12 comprises wood chips.

The upper surface 10a of the outer wall 10 is offset vertically from the upper surface 11a of the inner wall 11. The upper surface 11a of the inner wall 11 is higher than the upper surface 10a of the outer wall 10. Likewise, the lower surface 10b of the outer wall 10 is offset vertically from the lower surface 11b of the inner wall 11. The lower surface 11b of the inner wall 11 is higher than the lower surface 10b of the outer wall 10.

The module 1 comprises a flap 15 positioned on the upper surfaces 10a, 11a of the outer wall 10 and the inner wall 11. The flap 15 has a step shape in order to form a sealed membrane.

FIG. 2 describes a wall portion comprising a plurality of modules 1. In the embodiment described in FIG. 2, the wall comprises two modules 1a, 1b superimposed one above the other. The upper module 1a is mounted on the lower module 1b so that the lower end 103b of the conduit of the module 1a is inserted into the upper end 103a of the module 1b. The upper module 1a is mounted on the lower module 1b so that the connecting pin 110 protruding from the lower surface 11b of the inner wall 11 of the upper module 1a is inserted into the recess 11 of the inner wall 11 of the lower module 11b.

The wall of modules 1a, 1b comprises a horizontal beam 2 so that said horizontal beam is arranged under the inner wall 11 of the lower module 1b. The horizontal beam 2 comprises an insulator arranged under the insulating layer 12 of the module 1b. The horizontal beam 2 comprises a recess 111 formed in its upper surface. The recess 111 of the horizontal beam 2 is arranged to accommodate the connecting pin 110 protruding from the lower surface 11b of the lower module 1b. A seal 16 is positioned at the junction between the horizontal beam 2 and the lower surface of the lower module 1b.

The wall of modules 1a, 1b comprises a slab extending perpendicularly to the modules. The wall of modules 1a, 1b is mounted on the slab 3 by means of the horizontal beam 2.

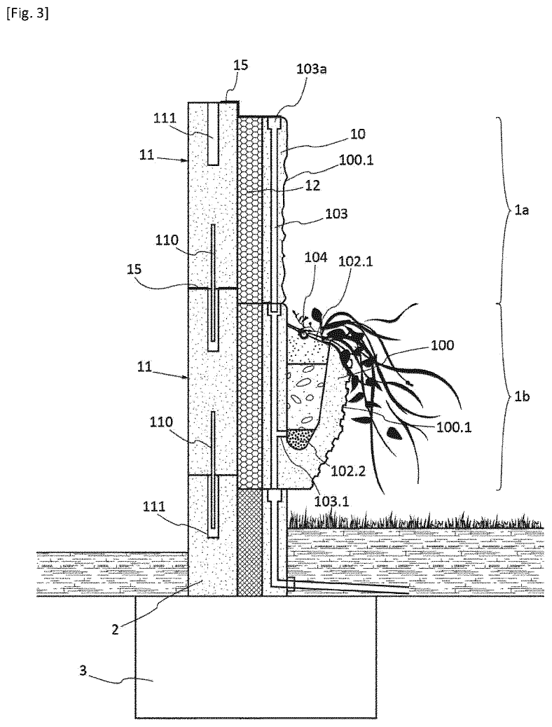

FIG. 3 describes a wall part comprising a plurality of modules 1. In the embodiment described in FIG. 3, the wall comprises a wall portion 1a and a module 1b superimposed one above the other. In the wall portion 1a, the outer wall 10 only comprises the attachment portion, the exterior surface of which comprises niches 100.1 adapted for the movement of small wildlife, for example insects or for their nesting.

The module 1b is substantially identical to that described in FIG. 1.

The inner wall 11 of the wall portion 1a is substantially identical to that of the module 1b. Thus, the wall portion 1a is mounted on the module 1b so that the connecting pin 110 protruding from the lower surface 11b of the inner wall 11 of the wall portion 1a is inserted into the recess 11 of the inner wall 11 of the module 11b.

The wall is mounted on a slab 3 by a horizontal beam, said slab 3 and said horizontal beam 2 being as described in FIG. 2.

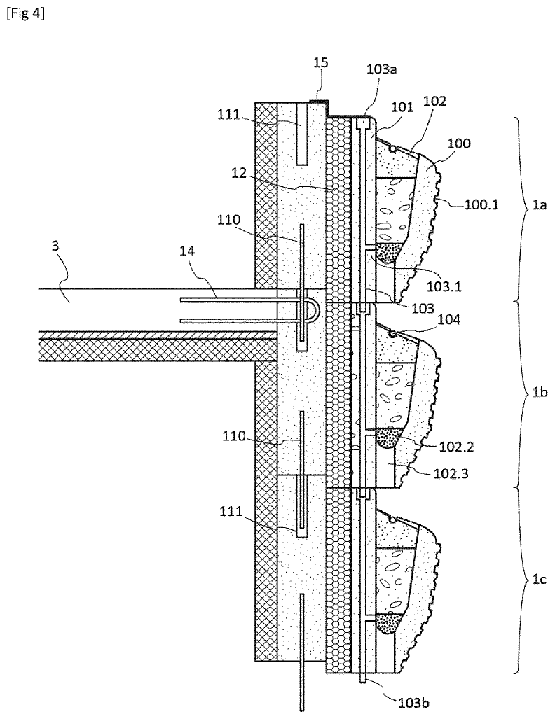

FIG. 4 describes a wall part comprising a plurality of modules 1a, 1b, 1c substantially identical to the module 1 described in FIG. 1. The wall is shown at the junction of two stories, in a non-seismic configuration, that is, for construction that is not dedicated to withstanding earthquakes. In this embodiment, a slab 3 is cast at an intermediate module 1b. The slab 3 is attached to the intermediate module 1b by a holding bar 14. The holding bar 14 comprises a U-shaped profile, the rounded part of the U being mounted in the inner wall 11 of the module 1b and the two arms being mounted in the slab 3. The rounded part of the holding bar 14 is arranged at the recess 111 adapted to receive the connecting pin 110. The holding bar 14 is thus adapted to reinforce the junction between the slab 3 forming a floor of a story and the load-bearing wall comprising the plurality of modules 1a, 1b, 1c.

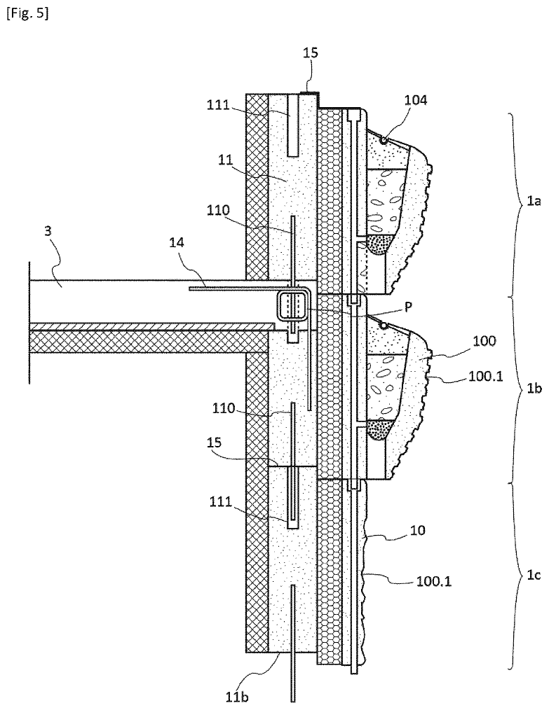

FIG. 5 describes a wall part comprising a plurality of modules 1a, 1b and a wall portion 1c. The modules 1a and 1b are substantially identical to the module 1 described in FIG. 1 and the wall portion 1c is substantially identical to the wall portion 1a described in FIG. 3. The wall is shown at the junction of two stories, in a seismic configuration, that is, for construction that is dedicated to withstanding earthquakes. As in the embodiment of FIG. 4, the slab 3 is cast at an intermediate module 1b. The slab 3 is attached to the intermediate module 1b by a holding bar 14. In this embodiment, an upper portion of the inner wall 11 of the intermediate module 1b is replaced by a portion of the slab 3, so that the end of said slab 3 is inserted between the inner wall 11 of the upper module 1a and the inner wall 11 of the intermediate module 1b. In this embodiment, the connecting pin 11 passes through the slab 3 so that a portion of the connecting pin 11 is in the upper module 1a, so that a portion of the connecting pin 11 is in the slab 3, and so that an end of the connecting pin 11 is in the recess 111 of the intermediate module 1b. A post P is arranged in the space provided between the two successive inner walls 11, that is arranged at the end of the slab 3. The holding bar 14 is arranged to form an L comprising a substantially right angle and two arms. The holding bar 14 is arranged so that the angle bears on the post P, so that one of the arms is in the slab 3 and so that the other of the arms is in the inner wall 11 of the intermediate module 1b. The holding bar 14 is thus adapted to reinforce the junction between the slab 3 forming a floor of a story and the load-bearing wall comprising the plurality of modules 1a, 1b, 1c and the wall portion 1c.

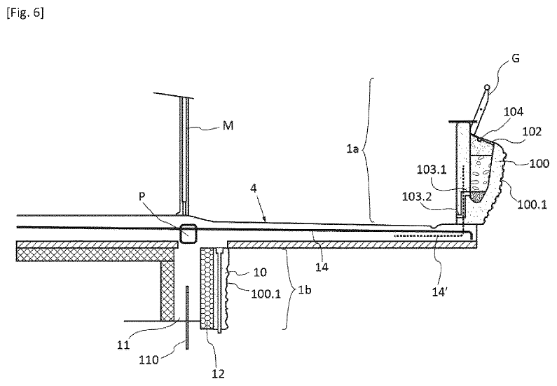

FIG. 6 describes a protruding balcony 4 of the module wall. The protruding end of the balcony 4 comprises a module 1a comprising only an outer wall 10. This module 1a is non-load-bearing. The wall portion 1b on which the balcony 4 rests is substantially identical to the wall portion 1a described in FIG. 3. The wall portion 1b is a load-bearing wall. The module 1a defining a wall of the balcony 4 comprises on the upper surface 10a of the outer wall 10, a guard rail G and more precisely on the upper surface 101a of the attachment portion 101. The guard rail G is made of steel sealed by mortar on the module 1a. The module 1a comprises a duct 103 passing through a portion of the attachment portion 101. The duct 103 of this embodiment comprises two ends, each of the ends comprising a bypass 103.1, 103.2. The first end comprising the bypass 103.1 opens out at the draining layer 102.2 of the volume 102. The second end comprising the bypass 103.2 opens out at a lower portion of the attachment wall 101, near the slab forming the balcony 4. Thus, the duct 103 comprises an S-shaped profile.

The slab forming the surface of the balcony 4 is protruding from the module 1b. The slab 4 comprises a post P housed in said slab 4. The post P is mounted above the inner wall of the module 1b. The slab 4 comprises a first holding bar running along the length of the slab 4, going as far as under the module 1a. The first holding bar 14 is integrated into the slab 4 so as to pass through the post P. The slab 4 comprises a second holding bar 14′ arranged to form an L comprising a substantially right angle and two arms. The second holding bar 14′ is arranged so that the angle is positioned under the module 1a so that one of the arms is in the slab 4 and that the other of the arms is in the attachment portion of the module 1a.

In this embodiment, a joinery section M is mounted on the slab forming the balcony 4. The joinery section M is arranged above the module 1b and joined on the slab 4.

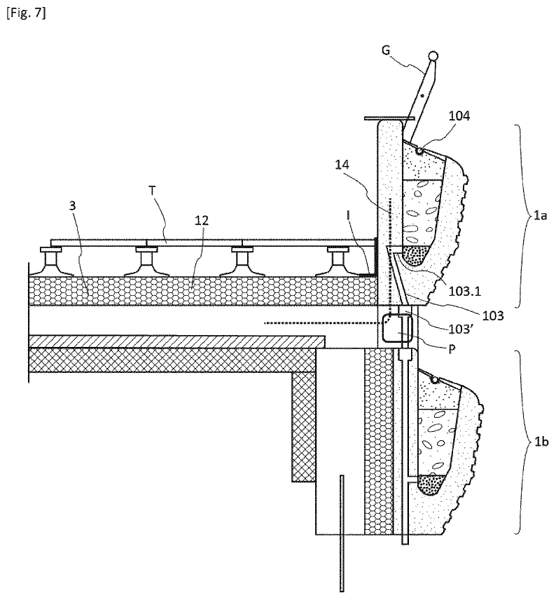

FIG. 7 describes a balcony aligned with a wall comprising a plurality of modules 1a, 1b. In this embodiment, the wall comprises a lower module 1b atop which a slab 3 rests, forming the surface of the terrace. The slab 3 rests on the inner wall 11 and on the attachment portion 101 of the lower module 1b. An upper module 1a is mounted on the slab 3 in an offset manner relative to the lower module 1b, that is, the lower surface 10b of the outer wall 10 is above a portion of the insulating layer 12 and above the attachment wall 101 of the lower module 1b. Thus, the slab 5 separates the upper surface 101a, 11a of the attachment portion 101 and of the inner wall 11 from the lower module 1b and the lower surface 10b of the outer wall 10 of the upper module 1a. The module 1a comprises a duct 103 passing through a portion of the attachment portion 101. The duct 103 of this embodiment comprises two ends. The first end comprises the bypass 103.1 opening out at the draining layer 102.2 of the volume 102. The duct 103 is oblique relative to the attachment portion 101a such that the second lower end 103b is aligned with the upper end 103a of the duct 103 of the lower module 1b. The second end 103.2 of the duct 103 of the upper module 1a and the upper end 103a of the duct 103 of the lower module are separated by another duct 103′ mounted in the slab 3.

The slab 3 comprises a post P housed in said slab 3. The post P is mounted between the upper module 1a and the lower module 1b. The slab 3 comprises a first holding bar running along the length of the slab 3, going as far as under the module 1a. The first holding bar 14 is integrated into the slab 3 so as to pass through the post P. The slab 3 comprises a holding bar 14 arranged to form an L comprising a substantially right angle and two arms. The holding bar 14 is arranged so that the angle is positioned through the post P and so that one of the arms is in the slab 3 and that the other of the arms is in the attachment portion of the upper module 1a. The connecting pin 110 of the upper module 1a is arranged to be inserted into the slab 3. Therefore, the upper module 1a is fixed to the slab 3 by the connecting pin 110 protruding from the lower surface 101b of the attachment portion 101, said connecting pin 110 being arranged to be inserted into said balcony 4.

The slab 3 comprises an upper surface on which an insulating layer 12 is mounted on which an earthwork T is mounted, for example a wood terrace on piles. An insulation joint I is mounted on the insulating layer 12, said joint being adapted to make the insulation between the insulating layer 12 and the upper module 1a.

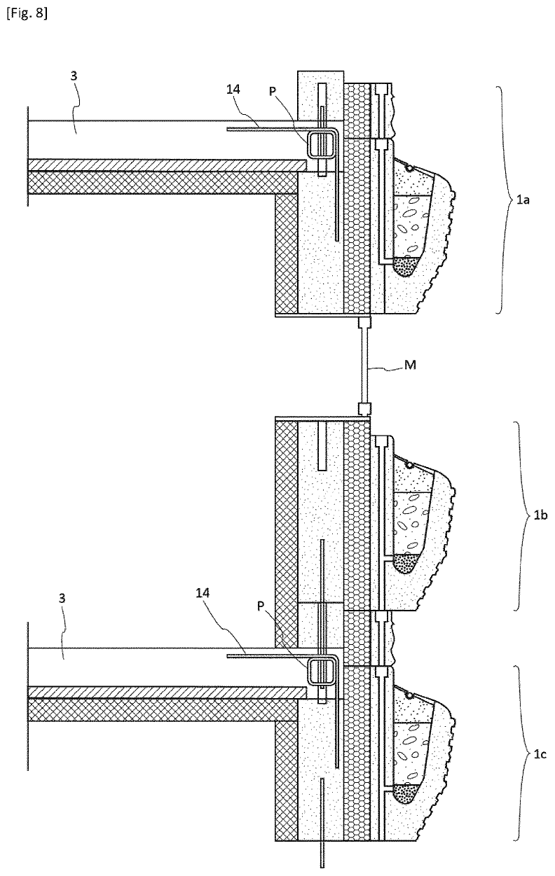

FIG. 8 describes a joinery section integrated into a wall comprising a plurality of modules. The wall comprises an upper module 1a, an intermediate module 1b and a lower module 1c. The configuration of the upper module 1a and the configuration of the intermediate 1b and lower 1c modules correspond to the description made in FIG. 5.

The lower surface 11b of the inner wall 11 of the upper module 1a and the upper surface 11a of the inner wall 11 of the intermediate module 1b each comprise a frame comprising an additional insulation on which the joinery section M is mounted. This embodiment is in particular a closed part comprising a joinery section or a loggia.

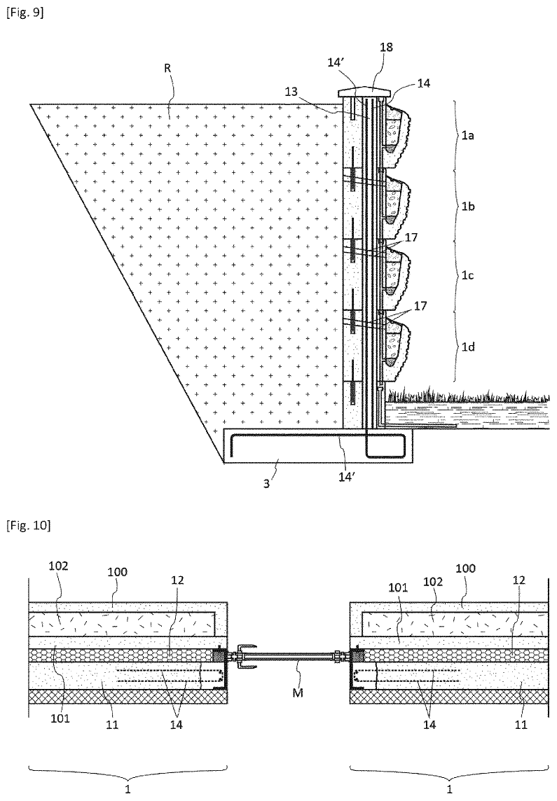

FIG. 9 describes a retaining wall of an embankment or backfill R comprising a plurality of modules. In this embodiment, the wall comprises an upper module 1a, two intermediate modules 1b, 1c and a lower module 1d. The modules 1a, 1b, 1c and 1d comprise an outer wall 10 and an inner wall 11 substantially identical to those described in FIG. 1. The upper surface of the upper module 1a is covered by a wall top. The wall of modules 1a, 1b, 1c, 1d is mounted on a slab 3 extending perpendicularly to the modules.

In this embodiment, the outer wall 10 and the inner wall 11 are separated by a space 13. For each module 1a, 1b, 1c, 1d, the outer wall 10 and the inner wall 11 are held together by connecting bars 17, said connecting bars 17 being adapted to pass through the empty space 13. The connecting bars 17 are clamped. The empty space 13 comprises a first holding bar 14 adapted to pass through the empty space 13 from the wall top 18 to the slab 3. The empty space 13 comprises a second holding bar 14′ arranged to form a loop comprising two ends. The second holding bar 14′ being arranged so that the loop and one of the ends are in the slab 3 and that the other of the ends is in the empty space 13 as far as the wall top 18. The first holding bar 14 and the other end of the second holding bar 14′ are substantially parallel in the empty space 13. The empty space 13 is filled with concrete so that the first holding bar 14 and the other end of the second holding bar 14′ are engaged in the concrete.

FIG. 10 describes a joinery section M integrated into a wall of modules. The joinery section M is a door. The joinery section M is mounted between two adjacent modules 1. Each module 1 comprises an outer wall 10 comprising a receiving portion 100 and an attachment portion 101 forming a volume 102. Each module 1 comprises an inner wall 11, the outer wall 10 and the inner wall 11 being separated by an insulating layer 12. The inner wall 11 comprises a holding bar 14 comprising a U-shaped profile, the rounded part of the U being mounted at the end of the inner wall 11 located near the joinery section M. The two ends of the U extending in the inner wall 11 in a direction opposite the joinery section M. The joinery section comprises a C-shaped vertical upright mounted so as to enclose the inner wall 11 and the insulating layer 12, the joinery section M being mounted on the vertical upright. A seal is mounted at the junction between the joinery section M and the vertical upright.

FIG. 11 describes a wall comprising a plurality of horizontally adjacent modules 1. The modules 1 of this embodiment comprise an outer wall 10 and an insulating layer 12 as described in FIG. 1. Two horizontally juxtaposed modules 1 define a decompression groove. The decompression groove comprises an expansion seal ensuring the junction between two adjacent modules 1. The expansion seal is arranged at the junction between two attachment portions 101 of two adjacent modules.

The modules 1 comprise an inner wall 11 comprising at each of its ends a lateral recess. At the lateral recess, the inner wall 11 comprises a rough strip. Two lateral recesses of two adjacent walls form a cavity wherein a post P is mounted, that is to say that a post P is mounted at the junction between two inner walls 11. Each inner wall 11 comprises at each of its ends a holding bar 14 comprising a U-shaped profile, the rounded part of the U being mounted in the post P and the ends of one of the holding bars 14 extending towards the other holding bar 14 mounted at the other end of said inner wall 11. Thus, each post P comprises the U of two holding bars 14 of two adjacent inner walls 11.

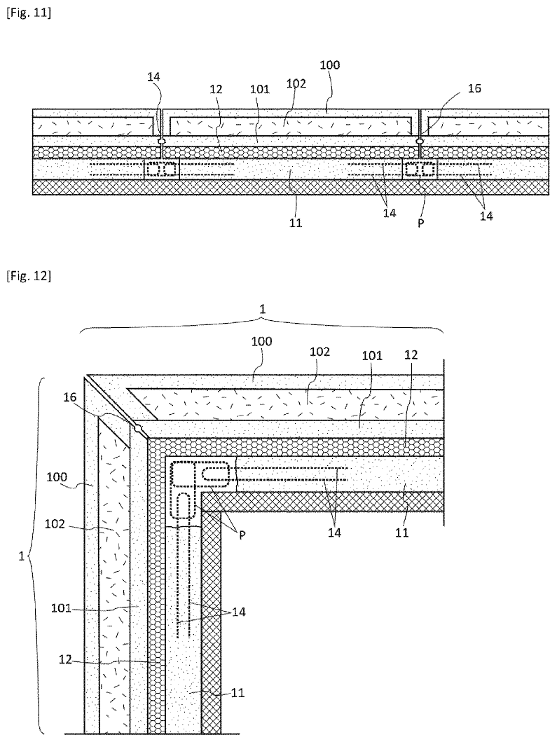

FIG. 12 describes a wall comprising a plurality of modules 1 arranged horizontally to form an exterior angle.

The modules 1 of this embodiment comprise an outer wall 10, an inner wall 11 and an insulating layer 12. In this embodiment, the receiving portion 100 is longer than the attachment portion 101 itself longer than the inner wall 11. Two modules 1 juxtaposed to form an exterior angle define a decompression groove. The decompression groove comprises an expansion seal 16 ensuring the junction between two adjacent modules 1. The expansion seal 16 is arranged at the junction between two attachment portions 101 of two adjacent modules.

The inner wall 11 comprises, at each of its ends, a lateral recess. At the lateral recess, the inner wall 11 comprises a rough strip. Two lateral recesses of two adjacent walls form an L-shaped cavity wherein two posts P are mounted forming a right angle, at the junction between two inner walls 11. Each inner wall 11 comprises, at each of its ends, a holding bar 14 comprising a U-shaped profile, the rounded part of the U being mounted in the post P and the ends of one of the holding bars 14 extending in a direction opposite that of the angle.

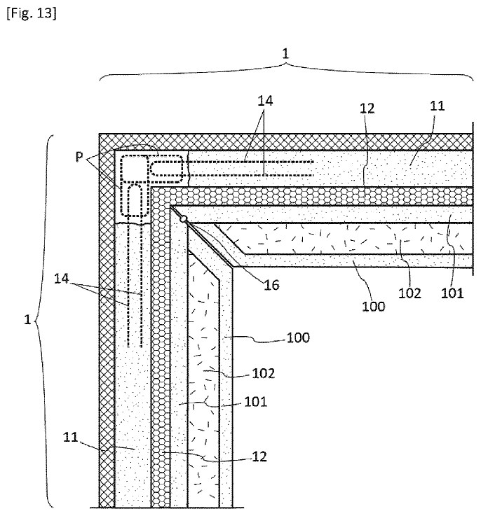

FIG. 13 describes a wall comprising a plurality of modules 1 arranged horizontally to form an interior angle.

The modules 1 of this embodiment comprise an outer wall 10, an inner wall 11 and an insulating layer 12. In this embodiment, the receiving portion 100 is shorter than the attachment portion 101 itself shorter than the inner wall 11. Two modules 1 juxtaposed to form an interior angle define a decompression groove. The decompression groove comprises an expansion seal 16 ensuring the junction between two adjacent modules 1. The expansion seal 16 is arranged at the junction between two attachment portions 101 of two adjacent modules.

The inner wall 11 is substantially identical to that described in FIG. 12.

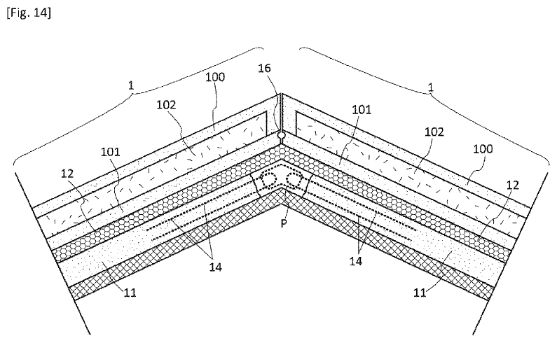

FIG. 14 describes a wall comprising a plurality of modules 1 arranged horizontally to form an angle greater than 90°.

The modules 1 of this embodiment comprise an outer wall 10, an inner wall 11 and an insulating layer 12. In this embodiment, the receiving portion 100 is longer than the attachment portion 101 itself longer than the inner wall 11. Two modules 1 juxtaposed to form an exterior angle define a decompression groove. The decompression groove comprises an expansion seal 16 ensuring the junction between two adjacent modules 1. The expansion seal 16 is arranged at the junction between two attachment portions 101 of two adjacent modules.

The inner wall 11 comprises, at each of its ends, a lateral recess. At the lateral recess, the inner wall 11 comprises a rough strip. Two lateral recesses of two adjacent walls form a V-shaped cavity wherein two posts P are mounted forming a substantially identical angle, at the junction between two inner walls 11. Each inner wall 11 comprises, at each of its ends, a holding bar 14 comprising a U-shaped profile, the rounded part of the U being mounted in the post P and the ends of one of the holding bars 14 extending in a direction opposite that of the angle.

The foregoing description clearly explains how the invention makes it possible to achieve the objectives that it set, namely to propose a solution that makes it possible to plant a facade while making it possible both to ensure a diversification of the plants installed on the facade and to ensure that the structure does not undergo any modification to plant the vegetation therein, saving time and money in the management of the structure, by proposing a planted wall module, comprising an outer wall prefabricated out of composite, the outer wall comprising an attachment portion and a receiving portion for defining a volume wherein a plant growth medium is arranged, the module further comprising an inner wall that can be likened to a load-bearing wall.

In any case, the invention is not limited to the embodiments specifically described in this document, and extends in particular to any equivalent means and to any technically operative combination of these means. It will in particular be possible to envisage that:
the outer wall 10 is prefabricated from prestressed concrete;
the attachment portion 101 and the receiving portion 100 form a V-shaped profile;
the lower end 102b of the volume 102 can be closed;
the insulating layer 12 comprises glass wool or mineral wool and/or a material made from plant fibers and/or a high-density extruded polymer and/or a polyurethane foam;
the module 1 comprises connecting bars adapted to fasten the outer wall 10 and the inner wall 11 to each other while passing through the insulating layer 12;
the guard rail G is a glass wall or a tubular structure associated with cables;
the wall comprises a cable or a lattice connecting two adjacent modules 1 vertically or horizontally.

1. A planted wall module (1), comprising an outer wall (10) prefabricated from reinforced or prestressed concrete, the outer wall (10) comprising an attachment portion (11) and a receiving portion (100) extending from a lower surface (101a) of the attachment portion (101) to define a volume (102) wherein a plant growth medium (102.1) is arranged, the wall (10, 11) comprising a duct (103) opening into the volume (102) on the one hand and outside the outer wall (10) on the other hand.

2. The planted wall module (1) according to claim 1, wherein the outer surface of the receiving portion (100) comprises a plurality of niches (100.1).

3. The planted wall module (1) according to claim 1, wherein the duct (103) extends from an upper surface (10a) of the outer wall (10) to a lower surface (10b) of the outer wall (10), said duct (103) comprises a bypass (103.1) opening into the volume (102).

4. The planted wall module (1) according to claim 1, wherein the module (1) comprises an inner wall (11), separated from the outer wall (10) by an insulating layer (12).

5. The planted wall module (1) according to claim 4, characterized in that it comprises connecting bars (17) adapted to fasten the outer wall (10) and the inner wall (11) to each other, said connecting bars (17) passing through the insulating layer (12).

6. The planted wall module (1) according to claim 1, wherein the outer wall (10) and/or the inner wall (11) comprises a connecting pin (110) extending from a lower surface (10b, 11b) of that wall (10, 11) and a recess (111) formed in that wall (10, 11) extending from an upper surface (10a, 11a) of that wall (10, 11).

7. The planted wall module (1) according to claim 1, wherein the upper surface (11a) of the inner wall (11) is offset vertically from the upper surface (10a) of the outer wall (10) and/or the lower surface (11b) of the inner wall (11) is offset vertically from the lower surface (10b) of the outer wall (10).

8. The planted wall module (1) according to claim 1, wherein the receiving portion (100) comprises a bore (102.3) formed under the volume (102).

9. The planted wall comprising a plurality of modules (1) according to claim 1.

10. The planted wall according to claim 9, characterized in that it comprises a post (2) and in that at least one of the modules of said plurality of modules is mechanically connected to the post (2).

11. The planted wall according to claim 9, characterized in that it comprises a slab (3) extending perpendicularly to the modules (1) and in that at least one of the modules of said plurality of modules is mechanically connected to the slab.

12. The planted wall according to claim 9, wherein, at least two modules (1) are juxtaposed horizontally so as to accommodate a post in the lateral spaces provided at the ends of the inner walls of these modules and facing each other, holding bars supported by the post being taken in these inner walls.

13. A balcony comprising a plurality of modules (1) according to claim 1, the modules being juxtaposed horizontally.

14. A method for manufacturing a module (1) according to claim 1, wherein the module is made by molding reinforced or prestressed concrete in a mold.

15. A mold adapted to be used in the manufacturing method according to claim 14 of a module (1).
